(19) United States
(12) Patent Application Publication
(10) Pub. No.: US 2006/0125602 A1
(43) Pub. Date: Jun. 15, 2006

(54) Active multiplexer for a multiple antenna transceiver

(76) Inventors: Joshua Posamentier, Oakland, CA (US); Rish Mehta, San Francisco, CA (US)

Correspondence Address: TROP PRUNER & HU, PC, 8554 KATY FREEWAY, SUITE 100, HOUSTON, TX, 77024, US

(21) Appl. No.: 11/007,898

(22) Filed: Dec. 9, 2004

(51) Int. Cl. G08B 13/14

(52) U.S. Cl. 340/10.3; 340/10.4

(57) ABSTRACT

A single antenna may be powered to illuminate or transmit to a receiver such as an RFID tag. That tag may then provide a responsive signal to a plurality of antennas, each of which are active. The signals from those antennas may be analyzed to determine which signal has the highest quality. This may be used to select a particular signal for future analysis or to select a particular antenna for use as both a transmission and reception antenna for future operations. For example, the antenna which provides the strongest signal may be utilized to further illuminate a given RFID tag.

### BACKGROUND

This invention relates generally to wireless transceivers that transmit and receive radio frequency information.

Generally, a wireless transceiver transmits information and receives information. It may use common components for some aspects of the receive and transmit operation.

One radio frequency transceiver is called a radio frequency identification (RFID) reader/writer (to be referred to as simply an RFID reader). A radio frequency identification tag may be an integrated circuit with a tag insert or inlay including an integrated circuit attached to an antenna. An RFID reader communicates with the tag. The RFID reader may be a fixed antenna or a portable device such as a barcode scanner.

RFID systems may be utilized to determine the current location of articles of interest. A conventional RFID application is a dock door device. It determines which components, which have RFID tags on them, pass through a loading dock door. Many other applications may also be envisioned including electronic toll collection, sensor applications, inventory control and tracking, asset tracking and recovery, tracking manufacturing parts, tracking goods in supply chains, and payment systems, to mention a few examples.

RFID systems may be active systems which are battery powered or passive systems that are powered by the reader. Active systems may be used, for example, in toll booths, while passive systems may be for asset management, as one example.

Generally, RFID systems use one of four frequencies including a low frequency of 125 or 134.2 kilohertz, a high frequency of 13.56 megaHertz, an ultrahigh frequency (UHF) of 868 to 960 megahertz, and a microwave at 2450 megahertz. Each tag may be tuned to work with the material it is mounted on. Thus, depending on what the tag is mounted on, the tag may require a slightly different antenna design.

Conventional passive full duplex RFID systems utilize multiple antenna ports, but not at the same time. Each RFID reader ‘port’ may consist of either one antenna that both transmits and receives or two antenna elements, each of which only transmits or receives but are switched in tandem as a pair. For clarity, these examples will focus on the particular reader design whose ports consist of a single antenna element each which both transmits and receives. The four port RFID reader would then have four antenna elements and one active set of transmit and receive circuitry and a multiplexer which would, at any given time, leave several antennas unused.

Thus, there is a need for better ways to provide wireless transceivers, including those used in RFID systems.

### BRIEF DESCRIPTION OF THE DRAWINGS

FIG. 1 is a schematic depiction of one embodiment of the present invention;

FIG. 2 is a flow chart for software which may be provided on the diversity controller shown in FIG. 1 in accordance with one embodiment of the present invention; and

FIG. 3 is a system depiction for one embodiment of the present invention.

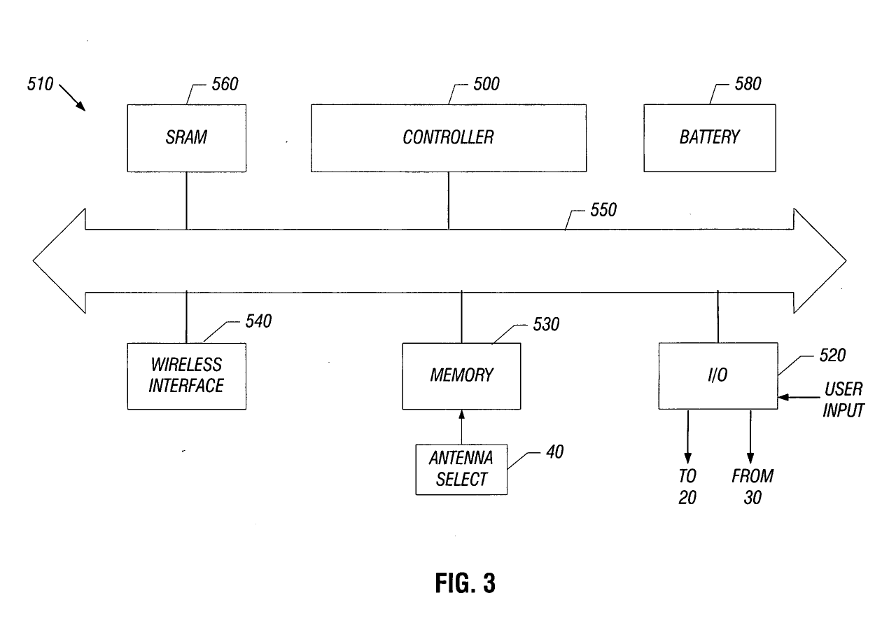

### DETAILED DESCRIPTION

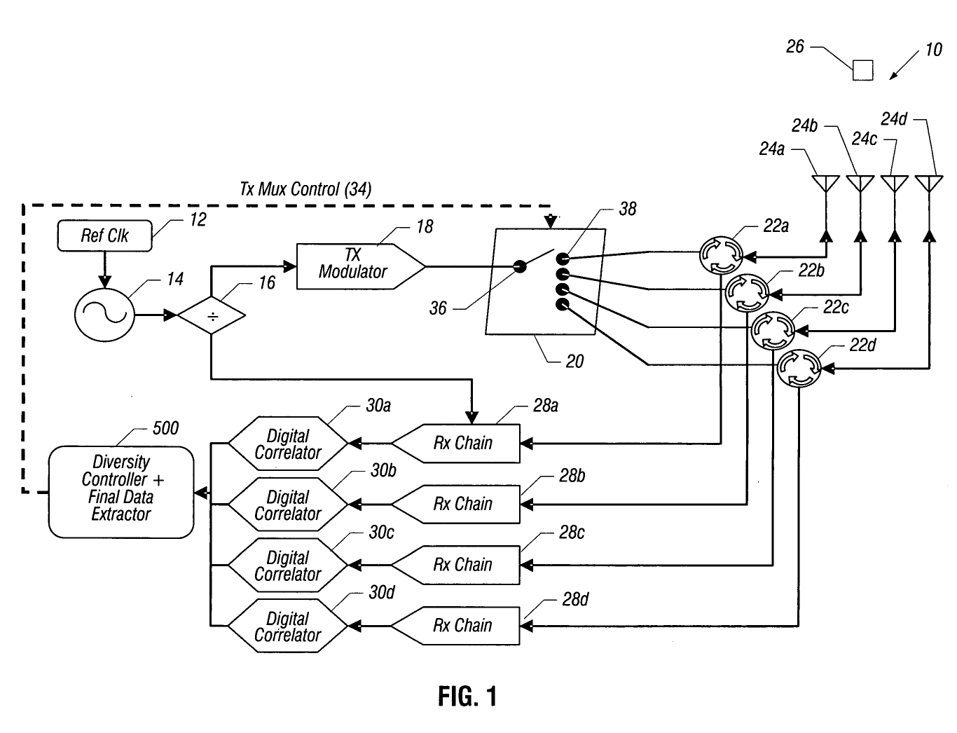

Referring to FIG. 1, a transceiver 10 may communicate with a device 26 which, in one embodiment, may be a radio frequency identification (RFID) tag 26. The system 10 may include multiple antennas. In the embodiment depicted, four antennas 24a, 24b, 24c, and 24d are used, but any number of antennas may be utilized.

Following the transmit path, a reference clock 12 develops a clock signal which powers a local oscillator 14. The output of the local oscillator 14 is power divided by a power divider 16 to reduce the power as supplied to a transmission modulator 18. The transmission modulator 18 provides an output signal to illuminate or power a tag 26, in one embodiment of the present invention, using a passive system.

The output from the modulator 18 is passed to one of the magnetic circulators 22a-22d. In one embodiment, a circulator 22 may be provided for each antenna 24. Other embodiments may using directional couplers or high isolation power dividers. The switching of the output of the modulator 18 may be accomplished by a switch 20 which may include three 1×2 switches in one embodiment of the present invention. Thus, a movable contact 36 may select one of the fixed contacts 38, as a simple example. Each of the contacts 38 may provide a signal to one of the circulators 22 and, ultimately, to one and only one of the antennas 24. Thus, a single antenna 24 may be selected for transmission. The switching may also be performed with solid state switches (e.g. Pseudomorphic High Electron Mobility Transistor Field Effect Transistor (PHEMT FET) switches or PIN diode switches) for increased switching speed and decreased cost.

Following the receive path, each of the antennas 24a-24d may receive a signal back from the tag 26 in one embodiment of the present invention. Thus, while one antenna 24 may be selected for transmission, all four antennas 24, which may be positioned in different locations, at least potentially receive a responsive signal from the tag 26. In the case of a passively illuminated tag 26, the antennas 24 receive back scattered radio frequency energy from the tag resulting from the illumination by the transceiver 10.

A received signal is provided from each antenna 24 to its associated circulator 22a-22d. The circulators 22 may have three ports and operate as directional couplers. Each circulator 22 isolates at least one of the input or output paths from the other of the input or output paths. The circulators 22 may also include integral power dividers. Any signal coming into a circulator 22 on a particular port can only go out on a particular output port with high isolation provided on the prohibited output port.

Each circulator 22 then communicates with a receive chain 28a-28d. Each receive chain 28 is coupled to a digital correlator 30a-30d. The correlators 30 are responsible for clock and data recovery from each receive chain 28. There may be no inherent synchronicity between the received signals and the data recovery and processing. As a result, it may be necessary in some embodiments to correlate the incoming data to recover the clock. Once the clock is recovered, the data is necessarily recovered.

After the data is recovered, the data may be provided to a diversity controller and final data extractor 500. In one embodiment, the controller 500 may be a programmable controller such as an embedded microcontroller. The diversity controller controls the transmission through a selected one of the antennas 24 and decides, in some cases, which received signal is the most useful signal. For example, the diversity controller 500, in one embodiment, may determine which of the received signals is the strongest and, therefore, is the best candidate for subsequent analysis. In other embodiments, the diversity controller 500 may correct for errors and even take votes between different potential channels.

As indicated in FIG. 1, the diversity controller 500 may communicate with the switch 20 to select the desired transmission path. Thus, in one embodiment, one antenna after another may be powered to provide an output signal to the tag 26 and each of the antennas 24 may be polled to determine what signal is received back on those antennas 24. Once the most appropriate transmission antenna is determined, that antenna may be permanently selected for one data recovery cycle. Thereafter, a new most suitable antenna may be determined for changed circumstances.

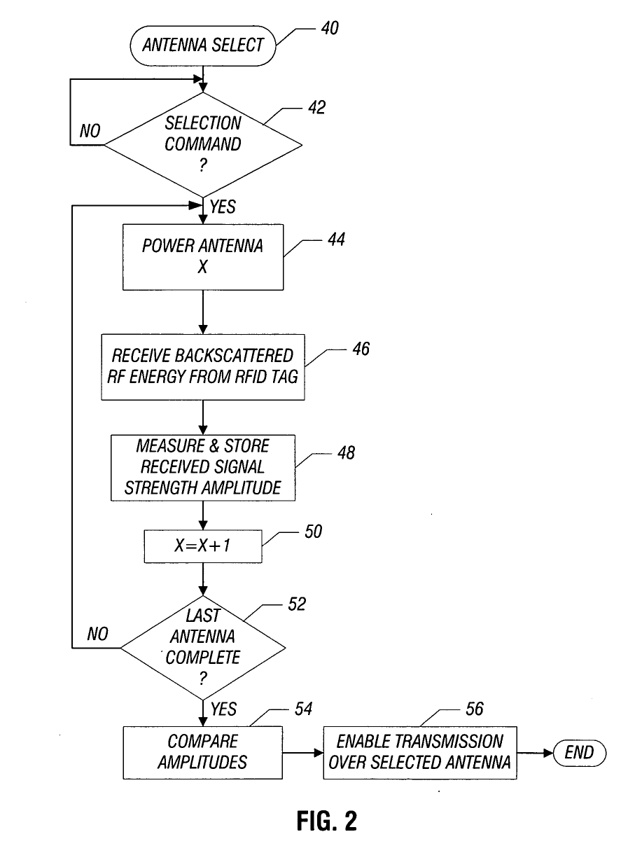

Referring to FIG. 2, in accordance with one embodiment of the present invention, the software 40 determines whether a selection command has been received in diamond 42. The selection command may be the result of the diversity controller's analysis of the outputs from the digital correlators 30 to 30d, for example to determine which of the received signals is the strongest. If a selection command has been developed, an output may be provided by the controller 500 to select a particular antenna X which may be one of the antennas 24a through 24d, as indicated in block 44.

Then, after the antenna 24 is powered up, the back scattered radio frequency energy from a tag 26 is received (block 46) by each of the antennas 24a through 24d. The received signal strength or amplitude is measured and stored as determined in block 48 and, then, the next antenna 24 may be powered up by incrementing the antenna number variable as indicated in block 50. Once all of the antennas have been analyzed as determined in diamond 52, the various amplitudes may be compared as indicated in block 54. Then, the diversity controller 500 may select a particular antenna 24 for subsequent transmission as indicated in block 56.

Thus, while only one antenna may transmit, in some embodiments of the present invention, multiple antennas may be listening. This may increase the read capability because there may be some tags that can be illuminated with one antenna but still cannot be heard well with that antenna. Because the same local oscillator may be utilized in some embodiments for both the transmission and receive paths, different receive chains may be enabled to function efficiently. For example, if there were independent radio frequency identification readers around a dock door they could all listen but, since they do not use the same local oscillator, their phase noise may be incoherent.

In accordance with some embodiments of the present invention, adaptive antenna switching may be based on antenna specific received power amplitude. In some embodiments, multi-path distortion may be mitigated through simultaneous tag reads. In other embodiments, interference mitigation may be achieved through the use of multiple active spatially diverse antennas and receive chains. Since it may be unlikely that all of the receive chains get desensitized by the same interferer, interference may be reduced with such an arrangement in some cases.

System 510 may include the controller 500, an input/output (I/O) device 520 (e.g. a keypad, display), a memory 530, a wireless interface 540, and a static random access memory (SRAM) 560, coupled to each other via a bus 550. It should be noted that the scope of the present invention is not limited to embodiments having any or all of these components.

Controller 500 may comprise, for example, one or more microprocessors, digital signal processors, microcontrollers, or the like. Memory 530 may be used to store messages transmitted to or by system 500. Memory 530 may also optionally be used to store instructions that are executed by controller 500 during the operation of system 510, and may be used to store user data. Memory 530 may be provided by one or more different types of memory. For example, memory 530 may comprise any type of random access memory, a volatile memory, or a non-volatile memory. The memory 530 may store the antenna selections 40.

I/O device 520 may be used by system inputs to the controller 500, for example, from the user to switch 20 via the control 34 (FIG. 1) and the receive user inputs and system inputs from the antennas 24 via the correlators 30 (FIG. 1). System 510 may use wireless interface 540 to transmit and receive messages to and from wireless tags with a radio frequency (RF) signal. Examples of a wireless interface 540 may include an antenna or a wireless transceiver, although the scope of the present invention is not limited in this respect.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
transmitting a signal over one of at least two antennas; and
receiving a response to said transmitted signal on both of said antennas.

2. The method of claim 1 including transmitting a signal to illuminate a radio frequency identification tag.

3. The method of claim 1 including transmitting a signal over one antenna selected by a switch.

4. The method of claim 3 including powering the one selected antenna through a magnetic circulator.

5. The method of claim 1 including receiving a response to the transmitted signal through a separate receive chain coupled to each antenna.

6. The method of claim 1 including transmitting a signal through an antenna selected based on the received signal strength of a received signal.

7. The method of claim 1 including comparing the signals received on each antenna.

8. The method of claim 7 including determining which of said received signals is the strongest.

9. The method of claim 8 including transmitting a signal over the antenna that previously received the strongest signal.

10. The method of claim 9 wherein transmitting a signal includes illuminating a radio frequency identification tag and receiving backscattered radio frequency energy from said tag on both of said antennas.

11. A radio frequency transceiver comprising:
a transmission modulator to selectively transmit a signal over one of at least two antennas; and
a first and second receive chains, said first and second receive chain coupled to a different antenna to receive a signal.

12. The transceiver of claim 11 wherein each receive chain is coupled to a device to analyze the strength of the received signal.

13. The transceiver of claim 12 including a controller to determine which antenna received the strongest signal.

14. The transceiver of claim 13 wherein said controller to provide a signal to select for the next transmission the antenna that received the strongest signal.

15. The transceiver of claim 15 including a switch coupled to said transmission modulator to enable one of at least two antennas to be selected for transmission.

16. The transceiver of claim 15 wherein said switch includes two 1×2 switch elements coupleable to four antennas.

17. The transceiver of claim 16 including a set of four antennas selectively connectable to said switch.

18. The transceiver of claim 17 wherein said antennas are coupled to said switch by magnetic circulators.

19. The transceiver of claim 18 wherein said circulators selectively provide output signals to said antennas and input signals to said receive chains.

20. The transceiver of claim 19 including a receive chain for each of four antennas such that each receive chain includes its own dedicated antenna.

21. An article comprising a medium storing instructions that, if executed, enable a transceiver to:
transmit a signal over one of at least two antennas; and
receive a response to said transmitted signal on both of said antennas.

22. The article of claim 21 further storing instructions that, if executed, enable the transceiver to transmit a signal to illuminate a radio frequency identification tag.

23. The article of claim 21 further storing instructions that, if executed, enable the transceiver to transmit a signal over only one antenna selected by a switch.

24. The article of claim 21 further storing instructions that, if executed, enable the transceiver to compare the signals received on each antenna.

25. The article of claim 24 further storing instructions that, if executed, enable the transceiver to determine which of received signals is the strongest.

26. The article of claim 26 further storing instructions that, if executed, enable the transceiver to transmit a signal over the antenna that previously received the strongest signal.

27. A system comprising:
a set of at least two antennas; and
a radio frequency transceiver, coupled to said antennas, said radio frequency transceiver including a transmission modulator to selectively transmit a signal over one of at least said two antennas, and a first and a second receive chain, said first and second receive chains coupled to a different antenna to receive a signal.

28. The system of claim 21 including a circulator to couple each antenna to said transceiver.

29. The system of claim 27 where each recieve chain is coupled to a device to analyze the strength of the received signal.

30. The system of claim 29 including a controller to determine which antenna received the strongest signal.

31. The system of claim 30 wherein said controller to provide a signal to select for the next transmission the antenna that received the strongest signal.

32. The transceiver of claim 31 including a switch coupled to said transmission modulator to enable one of at least two antennas to be selected for transmission.

33. The transceiver of claim 32 wherein said switch includes two 1×2 switch elements coupleable to four antennas.

34. The transceiver of claim 33 including a set of four antennas selectively connectable to said switch.

35. The transceiver of claim 34 wherein said antennas are coupled to said switch by magnetic circulators.

36. The transceiver of claim 35 wherein said circulators selectively provide output signals to said antennas and input signals to said receive chains.

37. The transceiver of claim 36 including a receive chain for each of four antennas such that each receive chain includes its own dedicated antenna.
